(19) United States
(12) Patent Application Publication
(10) Pub. No.: US 2009/0173607 A1
(43) Pub. Date: Jul. 9, 2009

(54) THIN KEYMAT MODULE WITH A REFLECTION STRUCTURE

(75) Inventors: HSIN-CHIN LEE, TAOYUAN COUNTY (TW); CHIO-LIEN YEH, TAIPEI COUNTY (TW); CHING-FENG HU, YILAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: SILITECH TECHNOLOGY CORP., TAIPEI HSIEN (TW)

(21) Appl. No.: 12/346,067

(22) Filed: Dec. 30, 2008

(30) Foreign Application Priority Data
Jan. 4, 2008 (TW) 97200216

(51) Int. Cl. H01H 9/00

(52) U.S. Cl. 200/310

(57) ABSTRACT

A thin keymat module with a reflection structure includes a circuit board with a plurality of elastic conductive elements, a mirror reflection sheet, a transparent elastic layer, a keymat layer and a light-emitting unit. The mirror reflection sheet is disposed on the circuit board, evenly corresponding to the elastic conductive elements. The mirror reflection sheet has a reflection microstructure corresponding to the elastic conductive elements. The transparent elastic layer is disposed on the mirror reflection sheet and has elastic portions corresponding to the elastic conductive elements. The keymat layer is disposed on the transparent elastic layer and has transparent portions corresponding to the elastic portions. The light-emitting unit is located on one side of the transparent elastic layer. When the light-emitting unit projects light onto the mirror reflection sheet and the reflection microstructure, each elastic portion and each transparent portion have a light displaying effect.

### BACKGROUND OF THE INVENTION

1. Field of the Invention

The present invention relates a thin keymat module, and more particularly to a thin keymat module with a mirror reflection sheet and a reflection Microstructure.

2. Description of Related Art

With the rapid development of communication technology, mobile phones become a common communication tool. Since mobile phones are light, thin and small, they are convenient for being carried, and besides, mobile phones can be designed to have various functions, so they are widely accepted by consumers. Generally, consumers mainly pay attention to the functions and appearances of mobile phones when purchasing mobile phones, which further promotes the development of the design and manufacture of mobile phones.

In the respect of keymat modules of mobile phones, for brightening characters on keymat modules, light emitting diodes (LEDs) need to be placed in areas desired to shine under the keymat modules for giving out light. Under the effect of material characteristics of rubber materials of the keymat modules, the light from the light emitting diodes is scattered and then changes the propagation direction to brighten the characters on the keymat modules.

However, since the rubber materials have low transparence, the loss of the light in the rubber materials is large so that the light cannot be propagated to slightly far areas. Also, it generally needs 6-8 light emitting diodes to brighten the areas around the characters on the keymat modules.

Some conventional keymat modules use materials with higher transparence to reduce the loss of light. however, they still need to dispose four light emitting diodes to be the light source. Accordingly, conventional keymat modules have the shortcomings of low light propagation efficiency and poor lighting uniformity.

Hence, the inventors of the present invention believe that the shortcomings described above are able to be improved and finally suggest the present invention which is of a reasonable design and is an effective improvement based on deep research and thought.

### SUMMARY OF THE INVENTION

A main object of the present invention is to provide a thin keymat module with a reflection structure which disposes a mirror reflection sheet and a reflection microstructure to cooperate with elastic conductive elements on a surface of a circuit board thereby becoming thinner and improving a light reflection effect. The present invention can improve the lighting brightness and lighting uniformity of the keymat module depending on a light source to achieve a good light displaying effect and avoid increasing the whole thickness of the keymat module. Furthermore, the present invention can improve the lighting brightness of the whole keymat module greatly and ensure that each keymat area of the keymat module emits light evenly during the shining of the keys of the keymat module.

Another object of the present invention is to provide a thin keymat module with a reflection structure which disposes a mirror reflection sheet and a reflection microstructure to achieve a light displaying effect under the action of light reflection but not light conduction of a light conduction assembly, thereby relieving constraints on the thickness of the keymat module effectively.

To achieve the above-mentioned objects, a thin keymat module with a reflection structure in accordance with the present invention is provided. The thin keymat module with a reflection structure includes a circuit board, a mirror reflection sheet, a transparent elastic layer, a keymat layer and a light-emitting unit. The circuit board has a plurality of elastic conductive elements. The mirror reflection sheet is disposed on the circuit board, evenly corresponding to the surfaces of the elastic conductive elements. The mirror reflection sheet has a reflection microstructure formed therein, which evenly corresponds to the plurality of elastic conductive elements and peripheries of the elastic conductive elements. The transparent elastic layer is disposed on the mirror reflection sheet and has a plurality of elastic portions corresponding to the plurality of elastic conductive elements. The keymat layer is disposed on the transparent elastic layer and has a plurality of transparent portions corresponding to the plurality of elastic portions. The light-emitting unit is located on one side of the transparent elastic layer.

Whereby, when the light-emitting unit projects light onto the mirror reflection sheet, the light is reflected by the mirror reflection sheet and the reflection microstructure so that each elastic portion and each transparent portion have a light displaying effect.

To further understand technologies, methods and efficacy of the present invention, please refer to the following detailed description and drawings related the present invention, and it is believed that the objects, characteristics and features of the present invention can be further understood. However, the drawings are only to be used as references and explanations, not to limit the present invention.

### BRIEF DESCRIPTION OF THE DRAWINGS

FIG. 1 is an assembled schematic view of a first embodiment of a thin keymat module with a reflection structure of the present invention;

FIG. 2 is an exploded schematic view of the first embodiment of the thin keymat module with a reflection structure of the present invention;

FIG. 3 is a partially enlarged view of part A in FIG. 1;

FIG. 4 is an assembled schematic view of a second embodiment of the thin keymat module with a reflection structure of the present invention;

FIG. 5 is a partially enlarged view of part B in FIG. 4; and

FIG. 6 is an assembled schematic view of a third embodiment of the thin keymat module with a reflection structure of the present invention.

### DETAILED DESCRIPTION OF PREFERRED EMBODIMENTS

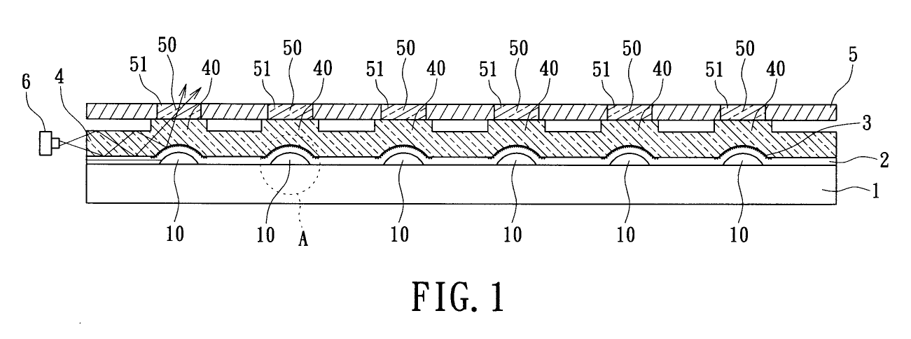

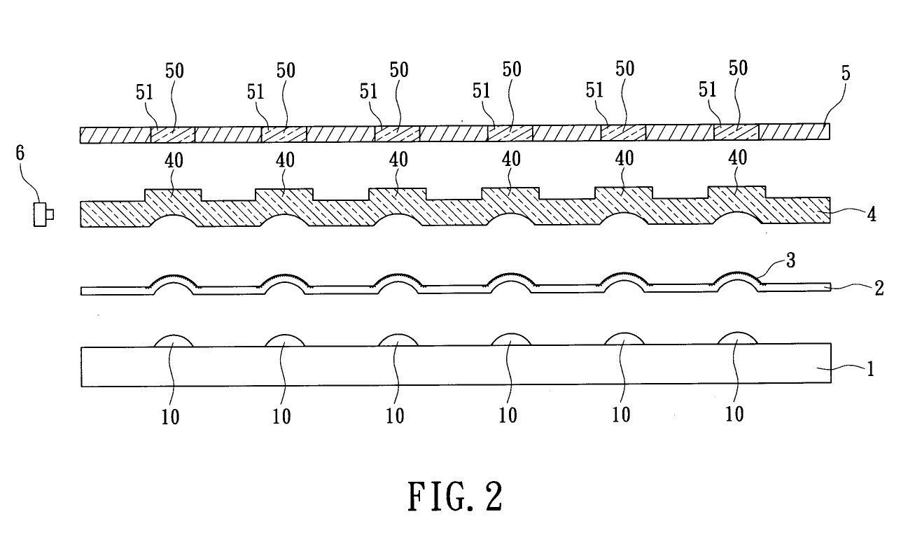

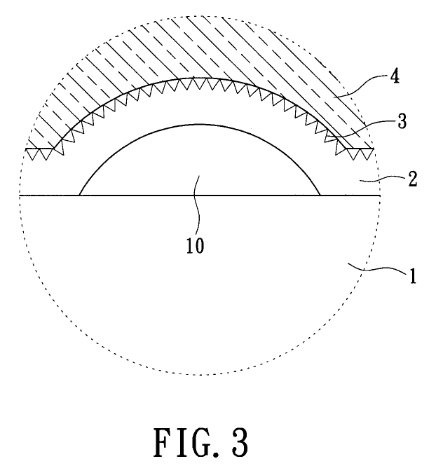

Please refer to FIGS. 1-3 illustrating a first embodiment of a thin keymat module with a reflection structure according to the present invention. The thin keymat module includes a circuit board 1, a mirror reflection sheet 2, a transparent elastic layer 4, a keymat layer 5 and a light-emitting unit 6.

The circuit board 1 has a plurality of elastic conductive elements 10 formed on a surface thereof, which is arranged at intervals. The elastic conductive elements 10 are made of an electrically conductive material, such as metal dome, for establishing an electrical connection with the circuit board 1. When pressed, each elastic conductive element 10 can elastically contact with the circuit board 1 to achieve the electrical connection.

The mirror reflection sheet 2 is disposed on the circuit board 1, evenly corresponding to the surfaces of the elastic conductive elements 10. The mirror reflection sheet 2 may be made of a high reflective material for a light reflection effect. The mirror reflection sheet 2 has a reflection microstructure 3 formed therein, which includes a plurality of microstructures respectively corresponding to the upper portions and the peripheries of the plurality of the elastic conductive elements 10 for improving the light reflection effect on the elastic conductive elements 10. The reflection microstructure 3 may have various geometric shapes which are helpful to improve the reflection effect, such as a triangular shape or a circular shape.

The transparent elastic layer 4 is disposed on the mirror reflection sheet 2 and the reflection microstructure 3. The transparent elastic layer 4 has a plurality of elastic portions 40 respectively corresponding to the upper portions of the plurality of elastic conductive elements 10. When any elastic portion 40 is pressed due to an external force, the elastic portion 40 can press the corresponding elastic conductive element 10 indirectly so that the elastic conductive elements 10 are electrically connected with the circuit board 1 to achieve an electrical conduction effect. In the embodiment, the transparent elastic layer 4 allows light to pass therethrough, so the transparent elastic layer 4 may be made of any transparent material. Additionally, each elastic portion 40 is a plunger which has a protruding structure so that users can easily contact with the elastic portion 40 and press it to indirectly lead the plurality of elastic conductive element 10 to establish the electrical connection with the circuit board 1.

The keymat layer 5 is disposed on the transparent elastic layer 4 and has a plurality of transparent portions 50 which are arranged at intervals. Each transparent portion 50 corresponds to one of the elastic portions 40 so that light can pass through the transparent elastic layer 4 and the transparent portions 50 and produce a light displaying effect on the keymat layer 5. The plurality of transparent portions 50 may have any shape, such as patterns, veins, words and numerals, so that the light shows a certain predetermined shape on the keymat layer 5, and uses can design different shapes according to their demands. Furthermore, each transparent portion 50 is filled with a transparent material 51 to achieve a remarkable light displaying effect. The transparent material 51 may be one of a transparent colloid, printing ink having a predetermined color and fluorescent powder having a predetermined color to achieve a light displaying effect of a special color. The predetermined color may be any color, such as red, green, blue, purple, and so on.

The light-emitting unit 6 is located on one side of the transparent elastic layer 4 to be a light source. The light-emitting unit 6 is at least one light emitting diode for providing a color changing effect.

Based on the structure of the above keymat module, when the light-emitting unit 6 projects light onto the mirror reflection sheet 2, the light can be reflected by the mirror reflection sheet 2 and the reflection microstructure 3 and then pass through each elastic portion 40 of the transparent elastic layer 4 to produce a light displaying effect on each transparent portion 50 of the keymat layer 5. Under the influence of the transparent material 51, the light displaying effect is more remarkable, so that relative shining shapes such as patterns, words and numerals and so on can appear on the area of each elastic portion 40. The keymat module can improve the brightness of the whole keymat module to a large extent and ensure that each keymat area of the keymat module emits light evenly during the shining of the keys of the keymat module.

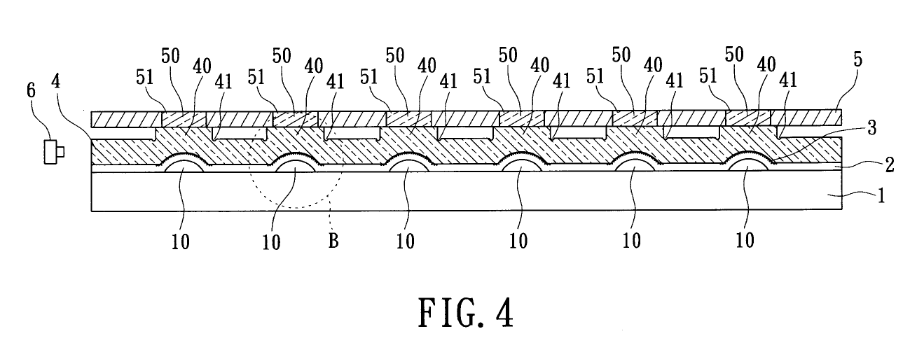

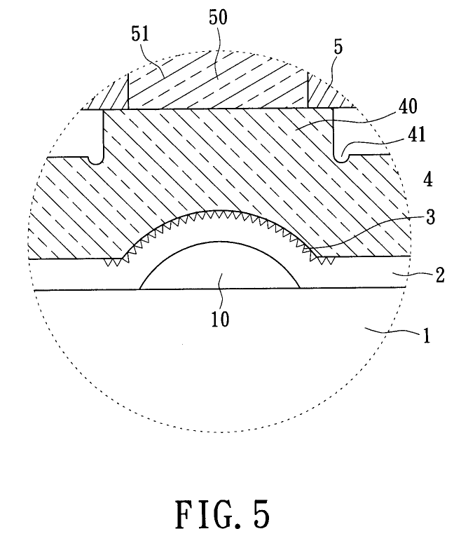

Please refer to FIG. 4 and FIG. 5 illustrating a second embodiment of the thin keymat module with a reflection structure according to the present invention. The difference between the second embodiment and the first embodiment is the difference of the transparent elastic layers 4. Each elastic portion 40 of the second embodiment is surrounded by a concave portion 41, and when any elastic portion 40 is pressed, the elastic portion 40 will move downwards to drive the elastic conductive element 10 indirectly to electrically contact with the circuit board 1 under the effect of the concave portion 41. In the embodiment, the concave portion 41 is shaped like a circular arc. However, the concave portion 41 isn't limited in shape.

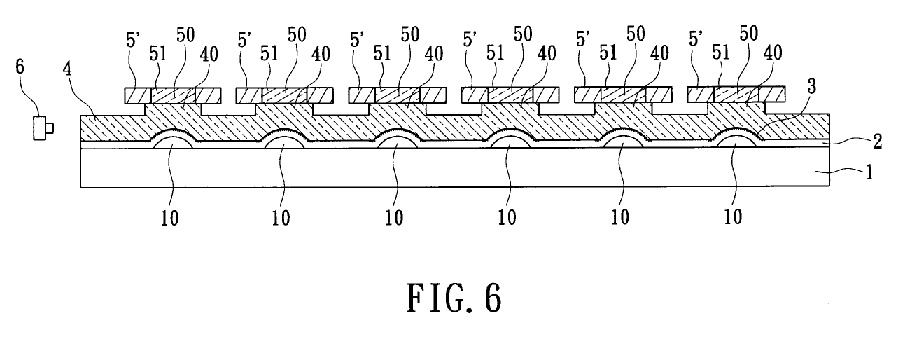

Please refer to FIG. 6 illustrating a third embodiment of the present invention. The design feature of the embodiment mainly is that the keymat layer 5 includes a plurality of keys 5′ which is arranged at intervals and disposed on the plurality of elastic portions 40 correspondingly. Each key 5′ has a transparent portion 50 and a transparent material 51 filling in the transparent portion 50. Under the reflection action of the mirror reflection sheet 2 and the reflection microstructure 3, light can produce an even and obvious light displaying effect on the surface of each key 5′.

Consequently, the thin keymat module with a reflection structure of the present invention has the advantages as follows:

(1). Based on the arrangement of the mirror reflection sheet and the reflection microstructure, the present invention not only becomes thinner, but also improves the light reflection effect and produces a good light displaying effect.

(2). The present invention doesn't need a light conduction assembly for light conduction and can achieve the light displaying effect under the action of light reflection but not light conduction of a light conduction assembly, thereby relieving constraints on the thickness of the keymat module effectively.

(3). The present invention can improve the lighting brightness of the whole keymat module greatly and ensure that each keymat area of the keymat module emits light evenly during the shining of the keys of the keymat module.

(4). The present invention improves the efficiency of the light source based on the design of the mirror reflection sheet and the reflection microstructure.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A thin keymat module with a reflection structure, comprising:
a circuit board, having a plurality of elastic conductive elements;
a mirror reflection sheet, disposed on the circuit board and the elastic conductive elements and having a reflection microstructure;
a transparent elastic layer, disposed on the mirror reflection sheet and having a plurality of elastic portions corresponding to the plurality of elastic conductive elements;
a key-press layer, disposed on the transparent elastic layer and having a plurality of transparent portions corresponding to the plurality of elastic portions; and
a light-emitting unit, located on one side of the transparent elastic layer;
whereby when the light-emitting unit projects light onto the mirror reflection sheet, the light is reflected by the mirror reflection sheet and the reflection microstructure so that each elastic portion and each transparent portion have a light displaying effect.

2. The thin keymat module with a reflection structure as claimed in claim 1, wherein each of the plurality of elastic portions is a plunger.

3. The thin keymat module with a reflection structure as claimed in claim 1, wherein the light-emitting unit is at least one light-emitting diode.

4. The thin keymat module with a reflection structure as claimed in claim 1, wherein the transparent elastic layer is made of a transparent material.

5. The thin keymat module with a reflection structure as claimed in claim 1, wherein each elastic portion is surrounded by a concave portion to improve a pressed characteristic of the elastic portion during being pressed.

6. The thin keymat module with a reflection structure as claimed in claim 1, wherein each transparent portion of the keymat layer is shaped like a pattern, a vein, a word or a numeral and filled with a transparent material.

7. The thin keymat module with a reflection structure as claimed in claim 6, wherein the transparent material is one of a transparent colloid, printing ink having a predetermined color and fluorescent powder having a predetermined color.

8. The thin keymat module with a reflection structure as claimed in claim 1, wherein each elastic conductive element is a metal dome.

9. The thin keymat module with a reflection structure as claimed in claim 1, wherein the mirror reflection sheet evenly corresponds to surfaces of the plurality of elastic conductive elements and the reflective microstructure corresponds to the elastic conductive elements and peripheries of the elastic conductive elements.
